(19) United States
(12) Patent Application Publication
(10) Pub. No.: US 2024/0183369 A1
(43) Pub. Date: Jun. 6, 2024

(54) VEHICLE MODULE CLIP

(71) Applicant: DAEHAN SOLUTION CO., LTD, Incheon (KR)

(72) Inventors: Choong Ho KWON, Seoul (KR); Deok Man LEE, Incheon (KR)

(73) Assignee: DAEHAN SOLUTION CO., LTD, Incheon (KR)

(21) Appl. No.: 18/387,495

(22) Filed: Nov. 7, 2023

(30) Foreign Application Priority Data
Nov. 29, 2022 (KR) 10-2022-0162256

(51) Int. Cl. F16B 2/20; B60N 3/02

(52) U.S. Cl. CPC F16B 2/20; B60N 3/026

(57) ABSTRACT

The present invention is directed to providing a vehicle module clip in which an angle formed between a pair of elastic arms, which perform a hooking operation while fitted to pass through a coupling hole and returning to an original state, is reduced to allow the elastic arms to be coupled to the coupling hole using a small force when the elastic arms pass through the coupling hole to perform the hooking operation and, when the module clip is separated from the coupling hole in a state in which the hooking operation is performed, lengths of the elastic arms decrease so that a greater force is required for allowing the elastic arms to be forcibly deformed and separated from the coupling hole so as not to easily separate the elastic arms from the coupling hole.

### CROSS-REFERENCE TO RELATED APPLICATION

This application claims priority to and the benefit of Korean Patent Application No. 10-2022-0162256, filed on Nov. 29, 2022, the disclosure of which is incorporated herein by reference in its entirety.

### BACKGROUND

### 1. Field of the Invention

The present invention relates to a vehicle module clip, and more specifically, to a vehicle module clip manufactured so that an angle formed between a pair of elastic arms, which are formed to face each other and perform a fixing operation while fitted into a coupling hole to decrease a gap therebetween, and returned to an original state, is reduced to decrease a distance between the elastic arms so as to allow hooks to be easily assembled with the coupling hole using a small force when the hooks are inserted into and assembled with the coupling hole and prevent the hooks from being easily separated from the coupling hole when the hooks are separated from the coupling after the assembly, thereby safely using the vehicle module clip.

### 2. Discussion of Related Art

In general, a module clip is used in a vehicle to couple two members into one such as when fixing an assist handle, and then to easily separate and reassemble the members as necessary. Such a module clip (fixture) is manufactured to be easily assembled or separated mainly using elasticity as described in Patent Document 1 to Patent Document 3 below.

### (Patent Document 1) Korean Patent Registration No. 10-1658519

The invention is directed to providing a fixture for mounting a vehicle auxiliary handle, which can be mounted easily using a small force when mounted and easily separated using a small force when separated as necessary. In particular, the invention is also directed to proving a fixture for mounting a vehicle auxiliary handle manufactured through a method of a pressing process or the like, in which widths, areas, heights, and the like of components are changed to mount or separate the fixture using a small force so as to mount or separate an auxiliary handle and a fixed state of the auxiliary handle is also stably maintained.

### (Patent Document 2) Korean Patent Registration No. 10-1275024

The invention is directed to providing a clip module for assembling a vehicle indoor handle, which improves the assembly performance of a clip using a minimum assembly force by minimizing a contact area between the clip for fixing an indoor handle and a vehicle body panel. In addition, the invention is also directed to providing a clip module for assembling a vehicle indoor handle, in which a pair of clips for fixing an indoor handle are integrally formed on a base plate to fix mounting positions of the clips or a fastening position of the indoor handle so that an assembly operation can be easily quickly performed through a one-touch method.

### (Patent Document 3) Korean Patent Publication No. 10-2013-0094887

The invention is directed to providing a clip module for assembling a vehicle indoor handle, in which an indoor handle is fixed through an insertion method using a divided pin type clip to easily quickly assemble the clip module without a fixing unit such as a screw so to improve productivity. In particular, the invention is also directed to providing a clip module for assembling a vehicle indoor handle in which an injection or extrusion method is adopted for each of a clip and a base plate to mass produce the clip module in a short time so as to further improve production efficiency.

### RELATED ART

### Patent Document

(Patent Document 1) Korean Patent Registration No. 10-1658519 (Registration Date: Sep. 12, 2016)
(Patent Document 2) Korean Patent Registration No. 10-1275024 (Registration Date: Jun. 10, 2013)
(Patent Document 3) Korean Patent Publication No. 10-2013-0094887 (Publication Date: Aug. 27, 2013)

### SUMMARY OF THE INVENTION

However, the conventional module clips have the following problems.

(1) In the conventional module clip, two hooks which are deformed by receiving elastic support are positioned to face each other, and a hooking operation is performed while the hooks are fitted into a coupling hole, contracted, and returned to an original state. Accordingly, in order for the module clip to be firmly fixed to a member, a force which deforms the two hooks when the hooks are fitted into the coupling hole, that is, an insertion force, should be great.

(2) Accordingly, an angle formed between portions of the hooks formed as one pair facing each other should be large. This is because, when the hooks are inserted into and assembled with the coupling hole, the hooking operation is performed while the angle of the portions of the hooks decreases and then increases, and thus a large force is required when assembling and a small force is required when the module clip is separated as necessary.

(3) When the module clip requires a small force, there is an advantage of separating the module clip using a small force for repairing or replacing a component or the like. However, normally, there is a concern that the module clip may be easily separated from a mounting position due to vibrations generated in a vehicle, an external force applied to the module clip by a driver or passenger, or the like.

(4) Such problems may cause injuries to the driver and passenger as the component fixed by the module clip is detached or separated therefrom.

The present invention is directed to providing a vehicle module clip in which an angle formed between a pair of elastic arms, which perform a hooking operation while fitted to pass through a coupling hole and returning to an original state, is reduced to allow the elastic arms to be coupled to the coupling hole using a small force when the elastic arms pass through the coupling hole to perform the hooking operation and, when the module clip is separated from the coupling hole in a state in which the hooking operation is performed, lengths of the elastic arms decrease, so that a greater force is required for allowing the elastic arms to be forcibly deformed and separated from the coupling hole, so as not to easily separate the elastic arms from the coupling hole.

According to an aspect of the present invention, there is provided a vehicle module clip fastened to a first member using a screw and fitted to pass through a coupling hole (11) formed in a second member (10), the vehicle module clip including a base (110) fixedly fastened to the first member using the screw and a pair of hooks (120) formed by partially bending both edges of the base (110) and assembled with the coupling hole (11) by being fitted into the coupling hole (11), wherein the base (110) includes guides (112) positioned between the two hooks (120) and cut and protrude from the base (110) to face each other, the guides (112) are formed so that a distance between two guides (112) decreases as a distance from the base (110) increases, and the hooks (120) include a pair of support arms (121) which are obliquely bent from both sides of the base (110) to face each other so that one edges of the support arms (121) are formed to be bent by predetermined widths to face each other, a pair of flanges (122) formed to extend from protruding ends of the support arms (121) toward both sides of the support arms (121) to face each other, two pairs of elastic arms (123) which are integrally obliquely formed on both sides of the flanges (122) facing each other in directions away from each other and in which a width (W) and an angle (θ) between two elastic arms (123) are 15.8 to 16.2 mm and 58 to 62°, respectively, and steps (124) bent to face each other from end portions of the elastic arms (123) and hooked in the coupling hole (11).

One or more beads (126) may be further formed on the support arms (121) outward from the base (110), and one or more beads (127) may be further formed on the elastic arms (123) outward from the base (110).

In addition, one or more noise prevention protrusions (125) may be formed on surfaces of the flanges (122) facing each other.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of an entire structure of a vehicle module clip according to the present invention;

FIGS. 2A and 2B are a set of views of a state in which the vehicle module clip is fastened to a second member according to the present invention, wherein FIG. 2A is a front view, and FIG. 2B is a side view;

FIG. 3 is a front view of the entire structure of the vehicle module clip according to the present invention;

FIG. 4 is a graph showing measured forces required for insertion and separation of the conventional module clip, which is a graph showing measured forces when the clip is perpendicularly inserted into and separated from a second member;

FIG. 5 is a graph showing measured forces required for insertion and separation of the module clip according to the present invention, which is a graph showing measured forces when the clip is perpendicularly inserted into and separated from a second member;

FIG. 6 is a graph showing measured forces required for insertion and separation of the conventional module clip, which is a graph showing measured forces when the clip is perpendicularly inserted into the second member and separated from the second member at an angle of 45°; and

FIG. 7 is a graph showing measured forces required for insertion and separation of the module clip, which is a graph showing measured forces when the clip is perpendicularly inserted into the second member and separated from the second member at an angle of 45°.

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

### [Structure of Vehicle Module Clip]

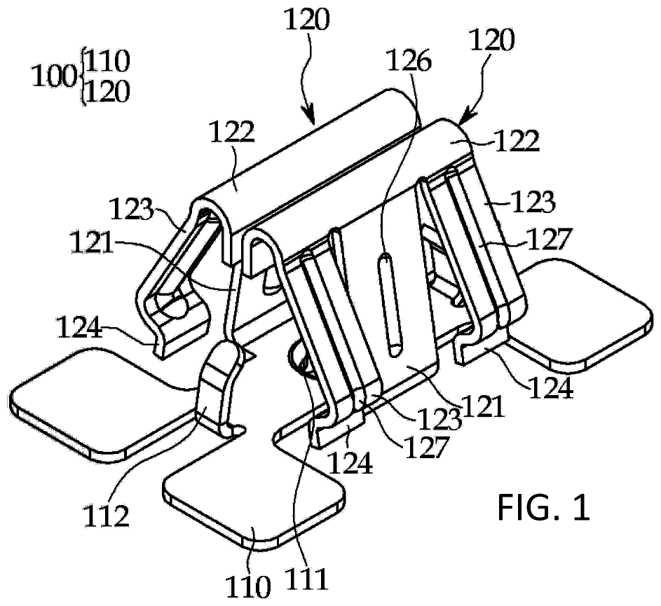

As illustrated in FIGS. 1 to 7, a module clip 100 according to the present invention includes a base 110 and a pair of hooks 120.

In particular, in the hooks 120, a width W and an angle θ formed between elastic arms 123 formed as one pair facing each other and in an arrowhead shape are formed as small as 15.8 to 16.2 mm and 58 to 62°, respectively. When the elastic arms 123 are fitted into and assembled with a coupling hole 11 formed in a second member, an interfering portion is small, and thus the elastic arms 123 can be easily fitted and assembled using a small force. Conversely, when the elastic arms 123 are separated, a large force is required to deform the elastic arms 123 due to the small angle, and thus the elastic arms 123 cannot be easily separated.

Hereinafter, such a structure will be described in more detail with reference to the accompanying drawings. In this case, a first member and the second member are members installed to face each other in a vehicle, and examples of the first member and the second member may be a head liner (first member) and an assist handle (second member).

### A. Base

As illustrated in FIGS. 1 to 3, the base 110 is integrally formed with the hooks 120, which will be described below, using a steel plate formed in a flat plate shape having a predetermined size. In this case, in the base 110, a fastening hole 111 is formed in a center, the hooks 120 are integrally formed at both edges, and guides 112 are formed between the hooks.

### 1. Fastening Hole

As illustrated in FIG. 1, the fastening hole 111 is formed to pass through a middle portion of the base 110 and used when the base 110 is in close contact with and integrally fixed to the first member using a screw or the like.

### 2. Guide

As illustrated in FIGS. 1 to 3, two guides 112 are formed on the base 110 to be positioned between the hooks 120 which will be described below. In this case, the guides 112 are formed to face each other and formed in bent shapes so that a distance between the two guides 112 facing each other decreases in an outward direction of the base 110.

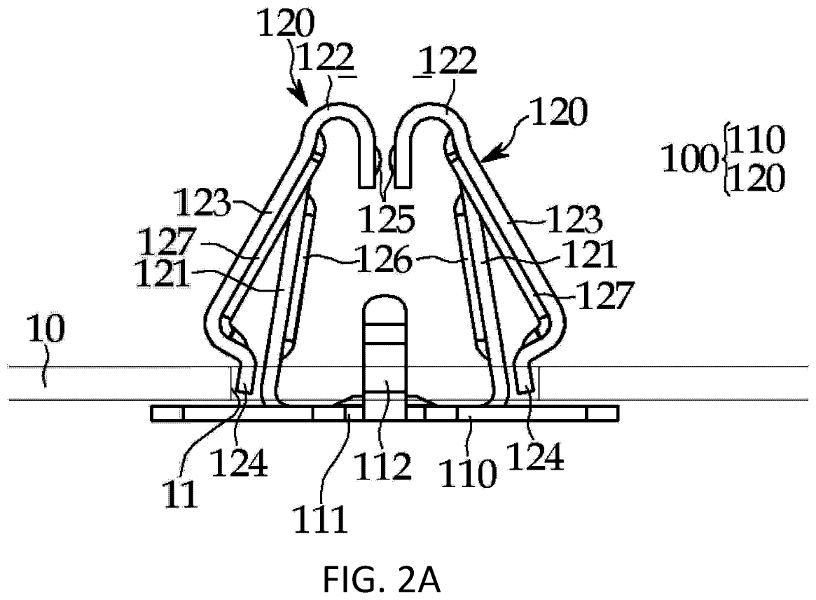

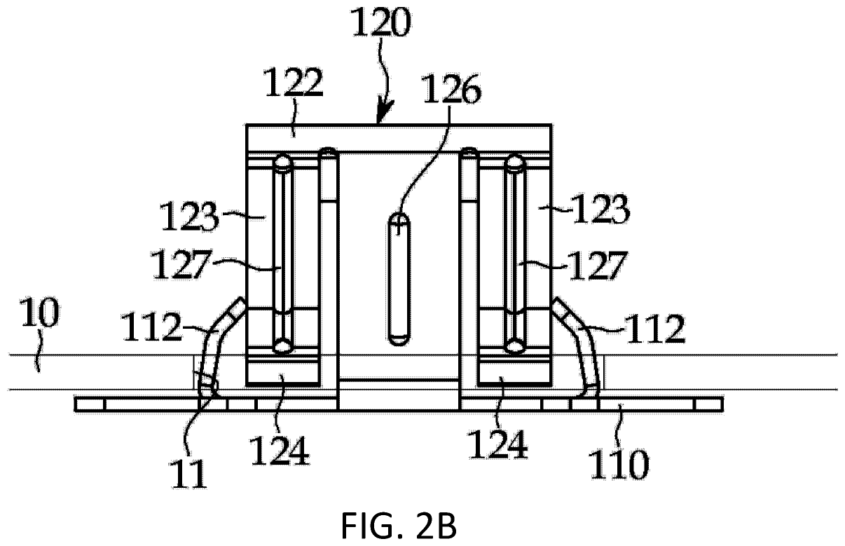

As described above, as the guides 112 are formed on end portions of both sides of the hooks 120 formed to face each other as illustrated in FIG. 2, when the module clip 100 according to the present invention is assembled, upper portions of the guides 112 are fitted into the coupling hole 11 of a second member 10 so that the module clip 100 is guided to be assembled at a predetermined position. In addition, lower portions of the guides 112 are in close contact with an inner surface of the coupling hole 11 formed in the second member 10 to prevent the module clip 100 from moving.

### B. Hook

As illustrated in FIGS. 1 to 3, the hooks 120 are integrally formed with the base 110 when a pressing process is performed on the base 110 and include support arms 121 formed at both sides of the base 110 to be obliquely bent toward each other, flanges 122 formed to extend toward both sides from upper end portions of the support arms 121, two pairs of elastic arms 123 formed at both sides of the flanges 122 to face each other and be bent in directions away from each other, and steps 124 which are bent from end portions of the elastic arms 123 and hooked in the coupling hole 11 of the second member 10. In addition, the hooks 120 may further include noise prevention protrusions 125 and beads 126 and 127.

### 1. Support Arm

As illustrated in FIGS. 1 to 3, the support arms 121 are to firmly connect the hooks 120 to the base 110 and are symmetrically formed to be obliquely bent from both sides of the base 110 so that end portions of the support arms 121 face each other.

In addition, in order to reinforce the strength of each of the support arms 121, at least one bead 126 may be further formed in a longitudinal direction of the support arm 121. In this case, when several beads 126 are formed, the beads 126 may be formed in parallel.

### 2. Flange

As illustrated in FIGS. 1 to 3, the flanges 122 are for reinforcing the strength and rigidity of upper portions of the support arms 121, are bent to have predetermined lengths so that the end portions of the support arms 121 facing each other face each other, and extend toward both sides of the support arms 121 so that an overall shape of each of the support arms 121 and corresponding one of the flanges 122 is a “T” shape.

### 3. Elastic Arm and Step

As illustrated in FIGS. 1 to 3, the elastic arms 123 are formed to be widened in outward directions of both sides of the flanges 122 toward the base 110. That is, the elastic arms 123 are widened in the arrowhead shape, a distance between the elastic arms 123 decreases when the elastic arms 123 are fitted into the coupling hole 11, the elastic arms 123 return to an original state thereof when the elastic arms 123 are further fitted, and thus elastic arms 123 provide an elastic force.

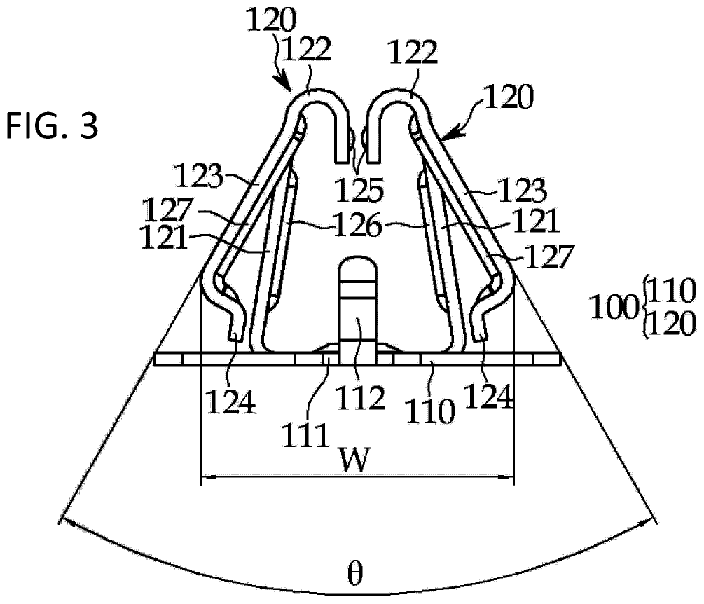

In the exemplary embodiment of the present invention, as illustrated in FIGS. 2 and 3, the angle θ and the width W formed between the two elastic arms 123 formed on the flanges 122 to face each other may be 58 to 62° and 15.8 to 16.2 mm, respectively. This is because, as the angle θ formed between the two elastic arms 123 is smaller than that of the conventional case, the elastic arms 123 having the arrowhead shape for passing through the coupling hole 11 may be easily deformed to correspond to a diameter of the coupling hole 11 to reduce a force used for assembly. Conversely, when an external force is applied to the elastic arms 123 coupled to the coupling hole 11, since lengths of the elastic arms 123 are smaller than those of the conventional case, a greater force is applied when a smaller length is deformed as compared to a greater length, and thus a greater force is required to forcibly deform the elastic arms 123 to separate the elastic arms 123 from the coupling hole 11, thereby preventing the module clip from being easily separated.

As illustrated in FIGS. 1 and 3, the steps 124 are formed on ends of the elastic arms 123, and, in particular, as the hooks 120 are fitted into the coupling hole 11, the elastic arms 123 are elastically deformed in directions facing each other, when the elastic arms 123 are completely fitted, the elastic arms 123 are returned to their original positions, and then the steps 124 are close contact with an inner circumferential surface of the coupling hole 11 to perform a hooking operation.

The elastic arms 123 and the steps 124 formed as described above are for fixing the module clip 100 to the coupling hole 11 of the second member 10. When the hooks 120 are positioned in and pushed toward the coupling hole 11, the elastic arms 123 are deformed to face each other, fitted into the coupling hole 11 of the second member 10, and then elastically restored again, accordingly, the steps 124 are in close contact with the inner surface of the coupling hole 11, and thus the module clip 100 is firmly fixed to the coupling hole 11.

Meanwhile, at least one long bead 127 may be further formed on the elastic arm 123 in a longitudinal direction in order to improve the strength of the elastic arm 123. In this case, when several beads 127 are formed, the beads 126 may be formed in parallel.

### 4. Noise Prevention Protrusion

As illustrated in FIGS. 2 and 3, one or more noise prevention protrusions 125, which suppress noise generated by mutual contact between the flanges 122 protruding in directions facing each other, are provided on surfaces of the flanges 122 facing each other. In this case, the noise prevention protrusions 125 may come into point contact with each other to minimize noise generation even when the module clip 100 is distorted when an external force is applied to the module clip 100.

As described above, according to the present invention, as the angle and the distance formed between the two elastic arms facing each other and formed in the arrowhead shape decrease, not only the hooks can be easily fitted into and assembled with the coupling hole, but a greater force is also required when the assembled hooks are separated from the coupling hole, and thus the assembled hooks can be prevented from being arbitrary detached or separated from the coupling hole.

### [Fitting Force and Separating Force Analysis Result]

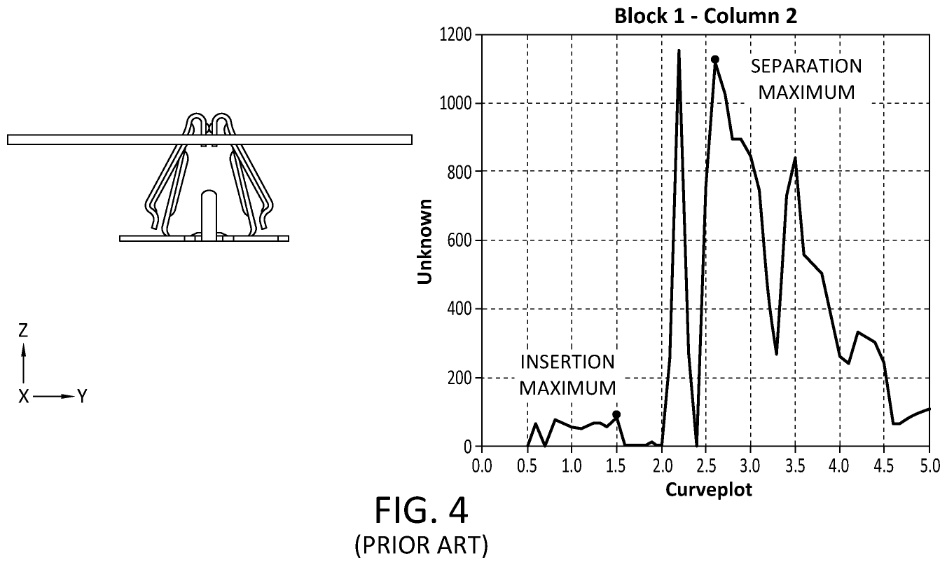

The result of simulating forces used for insertion and separation of the module clip (example) according to the present invention formed as described above and the conventional module clip (comparative example) is shown in FIGS. 4 to 7.

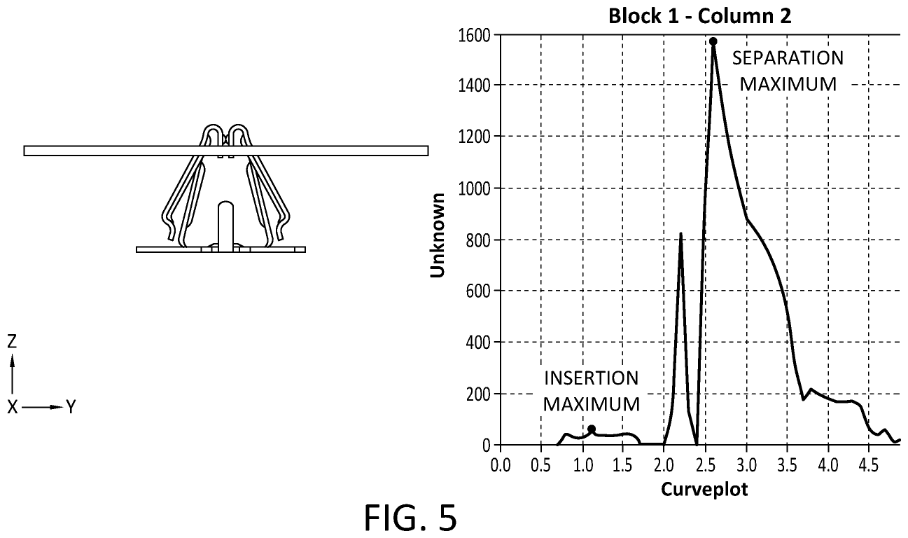

FIGS. 4 and 5 are graphs showing forces applied when the example and the comparative example are perpendicularly inserted into and assembled with the first member and then perpendicularly detached (separated) from the first member. As a result, it can be seen that, in the comparative example, a maximum force for insertion is 8.1 kgf and a force for separation (removal) is 113.7 kgf as shown in FIG. 4, and in the example, a maximum force for insertion is 4.4 kgf and a maximum force for separation is 158.5 kgf as shown in FIG. 5. As described above, the example can be assembled using a small force and cannot be easily separated.

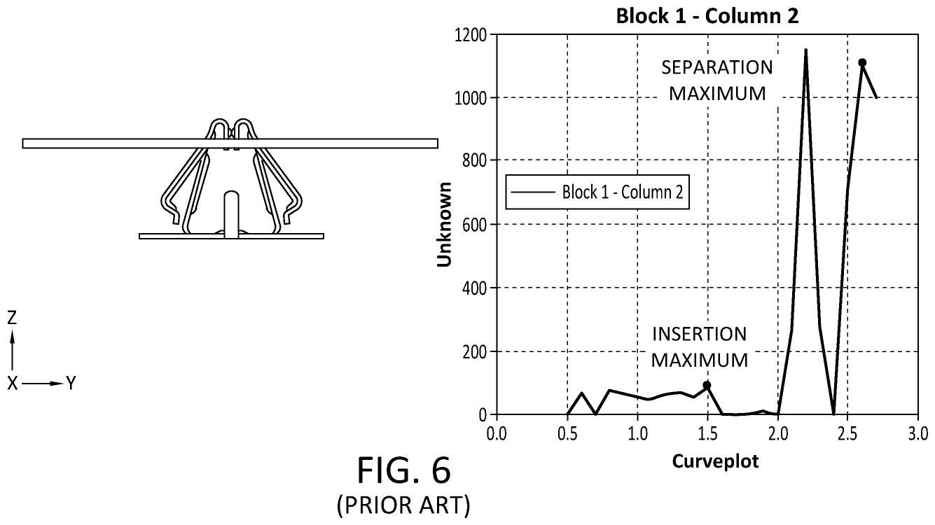

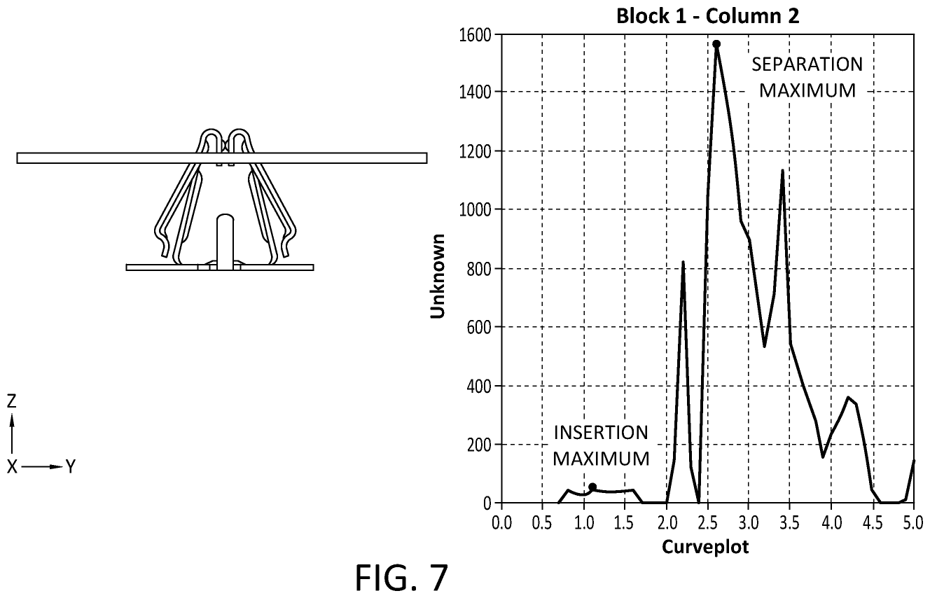

In addition, FIGS. 6 and 7 are graphs showing forces applied when the example and the comparative example are perpendicularly inserted into and assembled with the first member and then detached (separated) from the first member at an angle of 45°. As a result, it can be seen that, in the comparative example, a maximum force for insertion is 8.1 kgf and a force for separation (removal) is 117.9 kgf as illustrated in FIG. 6, and in the example, a maximum force for insertion is 4.4 kgf and a maximum force for removal is 159.2 kgf as illustrated in FIG. 7. As described above, the example can be assembled using a small force and cannot be easily separated.

A vehicle module clip according to the present invention has the following effects.

(1) As elastic arms are manufactured so that an angle formed between a pair of elastic arms, which face each other and perform a hooking operation while the pair of elastic arms pass through and are fitted into a coupling hole of a second member and a distance between the pair of elastic arms decreases and increases, is small, a magnitude of a force applied when the pair of elastic arms pass through the coupling hole to perform an assembly operation can be reduced. Accordingly, a module clip can be easily assembled using a small force.

(2) In addition, when an external force is applied to the module clip assembled as described above, since the elastic arms of which lengths decrease due to adjustment of the elastic arms should be forcibly deformed, a greater force is required as compared to a case in which lengths are long. That is, when the module clip is separated from the coupling hole, since a greater external force is required as compared to a case in which the angle between the elastic arms is large, the module clip once mounted is not easily detached or separated, and thus the module clip can be used safely.

What is claimed is:

1. A vehicle module clip fastened to a first member using a screw and fitted to pass through a coupling hole (11) formed in a second member (10), the vehicle module clip comprising:
a base (110) fixedly fastened to the first member using the screw; and
a pair of hooks (120) formed by partially bending both edges of the base (110) and assembled with the coupling hole (11) by being fitted into the coupling hole (11),
wherein the base (110) includes guides (112) positioned between the two hooks (120) and cut and protrude from the base (110) to face each other,
the guides (112) are formed so that a distance between two guides (112) decreases as a distance from the base (110) increases, and
the hooks (120) include a pair of support arms (121) which are obliquely bent from both sides of the base (110) to face each other so that one edges of the support arms (121) are formed to be bent by predetermined widths to face each other, a pair of flanges (122) formed to extend from protruding ends of the support arms (121) toward both sides of the support arms (121) to face each other, two pairs of elastic arms (123) which are integrally obliquely formed on both sides of the flanges (122) facing each other in directions away from each other and in which a width (W) and an angle (θ) between two elastic arms (123) are 15.8 to 16.2 mm and 58 to 62°, respectively, and steps (124) bent to face each other from end portions of the elastic arms (123) and hooked in the coupling hole (11).

2. The vehicle module clip of claim 1, wherein:
one or more beads (126) are further formed on the support arms (121) outward from the base (110); and
one or more beads (127) are further formed on the elastic arms (123) outward from the base (110).

3. The vehicle module clip of claim 1, wherein one or more noise prevention protrusions (125) are formed on surfaces of the flanges (122) facing each other.
